(19) United States
(12) Patent Application Publication
(10) Pub. No.: US 2003/0232737 A1
(43) Pub. Date: Dec. 18, 2003

(54) Compositions and methods for cleaning

(76) Inventors: Steven J. Stoessel, Niskayuna, NY (US); Frank J. Mondello, Niskayuna, NY (US)

Correspondence Address: Charles W. Calkins, Kilpatrick Stockton LLP, 1001 W. Fourth Street, Winston-Salem, NC, 27101, US

(21) Appl. No.: 10/171,312

(22) Filed: Jun. 13, 2002

(51) Int. Cl. C11D 17/00

(52) U.S. Cl. 510/417; 510/511

(57) ABSTRACT

A composition is provided which comprises at least one non-polar solvent in an amount less than 100 percent based on the total weight of the solution, at least one polar co-solvent in an amount up to 10 percent based on the total weight of the solution, at least one ionic surfactant, and at least one emulsifier in a sufficient amount to form a stable emulsion. The aforementioned composition may be employed to clean both polar and non-polar stains from various articles.

### FIELD OF THE INVENTION

This invention relates to the field of dry cleaning of clothing, textiles and the like. The invention is more particularly drawn toward novel dry cleaning fluids and methods of dry cleaning.

### BACKGROUND OF THE INVENTION

In the early days of dry-cleaning, kerosene was used to remove oil based stains from fabric. This proved dangerous as kerosene is highly flammable. Around the time of World War II, the dry cleaning industry used other volatile synthetic solvents such as, carbon tetrachloride and trichloroethylene. During the late 1940's and early 1950's these toxic compounds were replaced with perchloroethylene (PERC), which became the solvent choice for the industry. PERC was thought to be safer than its predecessors and produced a cleaner product, in less time, and with less equipment. This allowed for dry cleaning establishments to open in retail venues and offer quick turn around times.

PERC is an excellent dry-cleaning solvent. However, it has since been discovered that PERC is carcinogenic and an environmental hazard. There are some municipalities which have banned the use of PERC in the dry cleaning industry. Other common dry-cleaning solvents include Stoddard (hydrocarbon) solvents and siloxanes.

Whichever solvent is employed, professional dry-cleaning processes often use distillation to clean the solvent between uses. This process has a large energy cost and produces dangerous solvent vapors which must be recaptured and condensed for further use.

A frustrating issue faced by the dry-cleaning industry is the non-uniformity of dirt and stains which occur on article, particularly clothing. Stains can be separated into two general categories: lipophilic or oil-based compounds such as those left by body oils, fats and greases, cosmetics, and other highly aliphatic materials; and hydrophilic or water-soluble compounds such as fruit juice, ink and wine. A hydrophilic solvent will not dissolve oil-based stains and, conversely, a lipophilic solvent will not dissolve water-based stains.

Common practice in the dry cleaning industry is to pre treat or “spot clean” the water-based stains, and then dry-clean the garment, followed by a post treatment of any remaining water-based stain to ensure removal. This is a laborious process involving a close visual inspection of each garment, followed by the marking and treatment of stains with an appropriate cleaning method. To conduct the process in an acceptable manner not only requires considerable time and extra cleaning equipment, but also extensive experience to recognize and employ the correct cleaning techniques. Thus, it would be beneficial to use a solvent solution which could treat both water and oil-based stains, thereby eliminating the need for extra workers to inspect and treat garments with mixed stains.

There is no acceptable solution to the problem of mixed stains available to the individual consumer. Many garments are “dry-clean” only, as certain articles, such as silk and wool, will shrink or deform if they are washed in water. Therefore, these materials must be sent to a professional dry cleaner, which is an expensive and time-consuming endeavor. Furthermore, as discussed above, dry-cleaning may not be effective on all types of stains and workers may fail to detect all remaining stains before the article is returned to the consumer.

It would, therefore, be desirable to have a dry-cleaning cleaning fluid which is effective on both oil-based stains and water-based stains, and would not damage water-sensitive articles. It would be more desirable to have such a cleaning fluid that were also safe enough to be used by consumers in their home as well as by professional dry cleaners.

### BRIEF DESCRIPTION OF THE INVENTION

A composition is provided which comprises at least one polar co-solvent in an amount up to 10 percent based on the total weight of the solution, at least one ionic surfactant in an amount up to 1 percent based on the total weight of the solution, at least one emulsifier in an amount sufficient to form a stable emulsion and at least one non-polar solvent in an amount less than 100 percent based on the total weight of the solution. The aforementioned composition may be employed to clean both polar and non-polar stains from various articles.

In another aspect of the invention a composition is provided comprising 93 to 99 weight percent decamethylcyclopentasiloxane based on the total weight of the composition, 0.025 to 5 weight percent water based on the total weight of the composition, up to 1 weight percent of a siloxane based emulsifier based on the total weight of the composition and up to 1 weight percent of an ionic surfactant based on the total weight of the composition, where this composition is capable of solubilizing both polar and non-polar stains.

In another aspect of the invention a concentrated cleaning composition is provided comprising up to 60 percent by weight of at least one polar co-solvent, up to 7 percent by weight of at least one emulsifier, up to 10 percent by weight of at least one surfactant and at least one non-polar solvent in an amount less than 100 percent based on the total weight of the solution. This concentrated cleaning composition is capable of solubilizing both polar and non-polar stains.

In another aspect of the invention a method for cleaning articles is provided which comprises immersing the articles in a cleaning fluid which comprises at least one non-polar solvent, at least one polar solvent, at lest one ionic surfactant and at least one emulsifier. The articles are agitated in the cleaning fluid, then the cleaning fluid is separated from the articles.

### DETAILED DESCRIPTION

In traditional water-based laundering, detergents are employed to remove insoluble stains and particulates. As used herein, the term “stain” as it related to cleaning solutions and methods refers to any undesirable foreign substance. It may be organic or inorganic, clear or colored, hydrophilic or lipophilic, liquid or solid, and is not meant to be limited to any particular class of compounds. The insoluble stains in water-based laundering are often lipophilic and as such, do not dissolve in water. The detergents used in laundering employ surfactants, which are molecules containing both hydrophilic and lipophilic groups. Their dual nature allows them to dissolve in water through the hydrophilic group while the lipophilic groups surround the oil-based stain and remove it from the article. The oil droplets are surrounded by the lipophilic groups, kept suspended in the water, and carried away from the article in the wastewater stream. While this is a highly effective method of removing stains from articles, which are amenable to water based washing, there are articles that are damaged by excess water, thus this process cannot be used.

Dry cleaning is the cleaning of articles using limited amounts of water in the process. Dry cleaning solvents work by dissolving stains left on clothes. As would be expected, oil-based stains, such as those left by body oils, fats and greases, cosmetics, and other highly aliphatic materials that mar the appearance and performance of clothing, are readily removed. Water-based stains, typical of those left by food and beverages and fluid materials after the water of solvation has evaporated, need to be removed by other methods. This is traditionally conducted in the dry cleaning profession by spot cleaning. This is a laborious process involving a close visual inspection of each garment, followed by the marking and treatment of stains with an appropriate cleaning method. To conduct the process in an acceptable manner not only requires considerable time and extra cleaning equipment, but also extensive experience to recognize and employ the correct cleaning techniques.

A related problem is that most surfactants, particularly charged (ionic) surfactants, are completely insoluble in non-polar cleaning solutions. Thus it is difficult to introduce them into the cleaning medium. Non-ionic surfactants are more soluble in non-polar cleaning solutions, however, they are less effective in cleaning hydrophilic stains.

Another problem occurs because many fabrics are slightly polar, such that if a polar stain is removed from the article, it is likely to redeposit back onto the article before the end of the wash cycle. This occurs because the polar stain is more attracted to a high-energy surface such as the article, than a low energy medium such as the non-polar cleaning solution. This problem is discussed in more detail in “Surfactants and Interfacial Phenomena” 2^{nd} Ed., John Wiley & Sons, New York: 1989.

The invention includes a composition and method for cleaning articles at home or in a professional laundry. As used herein, the term “articles” is defined, for illustrative purposes and without limitation, as fabrics, textiles, garments, linens and any combination thereof. The compositions of the invention generally comprise at least one non-polar solvent, at least one polar solvent, at least one ionic surfactant, and at least one emulsifier. Various additives may also be employed in the practice of this invention as will be outlined later in this specification.

As used herein, the terms “emulsion” and “cleaning solution” are used interchangeably. Both refer to a composition comprising at least one non-polar solvent, at least one polar solvent and an emulsifier. The polar solvent is dispersed throughout the non-polar solvent in to form a microscopically heterogeneous stable dispersion.

Non-Polar Solvent

In one embodiment of the invention, the non-polar solvent component makes up the bulk of the cleaning emulsion. It may be present in any amount less than 100 percent and is preferably present in an amount greater than 75 percent, and more preferably from 93 to about 99 weight percent based on the total weight of the cleaning solution. The non-polar solvent functions to break up lipophilic stains on articles and carry the stains away from the article in the wash solution. The non-polar solvent is also the carrying medium for the other constituents of the cleaning solution. Suitable non-polar solvents for use in the invention include those that, while effectively eliminate lipophilic stains from article, will not discolor or fade the articles by attacking the coloring agents used therein. In one embodiment of the invention the non-polar solvents comprise, siloxanes, such as cyclic siloxanes. In another embodiment of the invention the non-polar solvent comprises decamethylcyclopentasiloxane. Small percentages of higher cyclic homologues such as, dodecylmethylcyclohexasiloxane, tetradecylmethylcycloheptasiloxane, and hexadecylmethylcyclooctasiloxane, may exist in the decamethylcyclopentasiloxane. In further embodiments of the invention non-polar solvents include supercritical carbon dioxide or fluorinated refrigerants such as chlorinated fluorocarbons. In still further embodiments of the invention, other petroleum distillates such as Stoddard petroleum distillate or mineral spirits or synthetic hydrocarbons such as Exxon's DF-2000™ may be employed.

Polar Solvent

Non-polar fluids are effective at removing lipophilic stains from articles. However, they are not effective at removing hydrophilic stains. Therefore, a polar solvent may be added to the cleaning solution to aid in the removal of such hydrophilic stains. The polar solvent employed in the invention functions to dissolve the water-based stains from the article to be cleaned. Additionally, the polar solvent carries hydrophilic additives which may be desirable in the cleaning solution. Polar solvents suitable for use in the invention include those that will break up and dissolve hydrophilic stains and can be emulsified in the non-polar solvent of the invention. Therefore, the polar solvent must be immiscible in the non-polar solvent so that they may be emulsified. In one embodiment of the invention, the polar solvent comprises water. Water provides a good polar solvent and is also readily solubilizes the ionic surfactants and additives used in some embodiments of the invention. In still further embodiments of the invention glycols, phenols, nitrites, aprotic solvents, ketones, aldehydes, simple alkyl alcohols and glycerin are some examples of suitable polar solvents.

Polar solvents do present a problem with certain articles. Traditional dry-cleaning was invented as a method of removing lipophilic stains, but it also allows for certain articles to be cleaned which do not react well to polar liquids. A polar solvent, such as water, when applied to certain articles may permanently discolor, mar or deform the article.

In some embodiments of the invention the amount of polar solvent may vary but will generally comprise a sufficient amount to provide an acceptable level of cleaning. In one embodiment of the invention the amount of polar solvent will be not greater than 20 weight percent based on the total weight of the solution. In another embodiment of the invention the polar solvent is present in an amount up to 10 weight percent based on the total weight of the solution. In a further embodiment of the invention the polar solvent is preferably present in an amount from about 0.25 to 5 weight percent based on the total weight of the solution, and more preferably present in an amount from about 1.5 to about 3.5 weight percent based on the total weight of the solution.

Emulsifier

In one embodiment of the invention the polar solvent and non-polar solvent may not be miscible in one another. In order to achieve an emulsion, an emulsifying agent may be employed. Surfactants make good emulsifiers for the purposes of this invention. In another embodiment of the invention non-ionic surfactants mat be employed as emulsifiers for the cleaning solution. They are more soluble in the non-polar liquid which comprises the major portion of the cleaning solution. Suggested emulsifiers include, but are not limited to; poly(ethylene glycol)s, poly(propylene glycol)s, sorbitan sesquioleate, sorbitan oleate, sorbitan isostearate, sorbitan trioleate, sodium bis(2-ethylhexyl)sulfosuccinate, polyglyceryl-3 oleate, fatty acid esters, and alkylalkoxy alcohols. In another embodiment of the invention, emulsifiers comprise sodium dodecylbenzene sulfate or sodium lauryl sulfate.

In further embodiments of the invention emulsifiers include siloxane based emulsifiers. Examples of these include ethoxylated and propoxylated siloxanes such as a dimethylsiloxane (60% propylene oxide, 40% ethylene oxide) block copolymer or siloxanes and silicones, dimethyl, 3-hydroxypropyl methyl, ethers with polyethylene-polypropylene glycol mono-butyl ether. Examples of these are sold under the trade names General Electric SF1188A and Toshu TSF 4452, respectively.

Emulsifiers used in the practice of this invention generally comprise 0 to 1.5 weight percent based on the total weight of the emulsion. However, one skilled in the art will recognize that the amount of emulsifier needed will vary according to types and amounts of polar and non-polar solvents used.

Ionic Surfactant

In one embodiment of the invention, an additional surfactant is employed to assist in cleaning any hydrophilic stains. An ionic surfactant reduces surface tension and surrounds the particle or hydrophilic stain and solubilizes it in the emulsion. The ionic surfactant may also assist in emulsifying the mixture. Surfactants suitable for use in cleaning compositions are known to those of skill in the art. Generally the ionic surfactants suitable for use in the invention comprise molecules with a highly charged head group and a hydrophobic tail, wherein the molecule further comprises a hydrocarbon tail of 12 to 20 carbon atoms. Further suitable surfactants for use in an embodiment of the invention may comprise a hydrophilic-lipophilic-balance (HLB) value of between 2 and 10.

While cationic, anionic, zwitterionic and amphoteric surfactants may be employed in the practice of the invention, anionic surfactants are preferred. Examples of suitable surfactants include, alkali metal soaps such as the sodium, potassium, ammonium, and alkylammonium salts of higher fatty acids containing from about 8 to 24 carbon atoms and alkali metal and ammonium salts of organic sulfuric reaction products having in their molecular structure and alkyl group containing from about 10 to about 20 carbon atoms and a sulfonic acid or sulfuric acid ester group. More specific examples of suitable surfactants include, but are not limited to, sodium dodecylbenzene sulfate, fluorinated surfactants like the DuPont Zonyl™ surfactants (such as Zonyl™ FSP or Zonyl™ FSK), sodium lauryl sulfate, sodium lauryl sulfonate, sodium state, sodium lauryl sulfate, ammonium lauryl ether sulfonate, dialkyldiethyloxylateammonium salt, perfluoroalkylsulfobetaines, perfluoroalkylphosphate, siloxane benzyltrimethylammonium salts, quaternary alkyl ammonium siloxanes, carboxyalkyl siloxanes and polyether siloxane surfactants.

In one embodiment of the invention, the ionic surfactant is present in an amount up to 2 percent based on the total weight of the solution. In another embodiment the ionic surfactant is present in an amount up to 1 weight percent based on the total weight of the solution.

Concentrated Cleaning Solution

In another embodiment of the invention, the cleaning solution may comprise a concentrated emulsion. In this embodiment the polar solvent, emulsifier, surfactant and additives are added to an amount of non-polar solvent in high concentrations to form a concentrated cleaning solution. In one embodiment of the invention, this concentrated cleaning solution may be mixed with excess non-polar solvent to dilute it before it is used. The relative amounts of these compounds will be significantly higher than in the non-concentrated embodiments described above. For example the polar solvent may comprise up to 60 percent by weight of the solution, the non-polar solvent may comprise up to 60 percent by weight of the solution, the emulsifier may comprise up to 7 percent by weight of the solution and the surfactant may comprise up to 10 percent by weight of the solution. In other embodiments additives may be included in the concentrated solution as well. It should be noted that regardless of the concentrations of the components of the concentrated solution, after mixing with excess non-polar solvent the relative concentrations of the components will be within the ranges given elsewhere in this specification.

Additives

In one embodiment of the invention, the cleaning solution comprises a variety of additives which enhance the effectiveness of the solution. These include disinfectants, deodorizers and brighteners among other additives.

Odor is largely a matter of perception. Individual humans do not perceive odors in the same manner; thus, what can be objectable to one person is not so to another. Secondly, people become habituated to constant odors and do not detect them after extended periods of time. Odors can be removed, neutralized, or masked with another scent. The course of action is largely dependent on the odor to be removed. For the purposes of the invention odor can be thought of as an invisible stain which is perceived through its effect on olfactory sensors.

Odor molecules can be chemically reacted to become odorless. Bleach is capable of oxidizing many organic compounds. However, as most articles are organic compounds, bleach will harm the article in the process. Disinfectants remove odor-producing bacteria. Soaps with general anti-bacterial properties commonly contain quaternary ammonium salts as the disinfectants. The quaternary ammonium chlorides have been established as effective odor-control materials in and of themselves, particularly in combination with perfumes. They are readily found in household cleaners. Citrus oils and some synthetic aldehydes have excellent masking and odor-countering abilities.

In one embodiment of the invention, effective deodorizers include ammonium bromide salts and dihexyldecyldimethylammonium salts. It should also be noted that odor removal is increased in the presence of certain polar solvents such as water and alcohol. In one embodiment of the invention, deodorizers are present in an amount up to about 1 weight percent based on the weight of the solution.

In other embodiments of the invention, odors are the result of bacteria and other microbes within the article, it is also desirable to add a disinfectant to the cleaning solution. Acceptable disinfectants include chlorine bleach, dimethyldichlorohydrantoin, ethanol, heptanal, glutaric dialdehyde, and Phenonip™.

Fabric Softeners

In one embodiment of the invention, one of the benefits of using certain non-polar solvents such as cyclic siloxane is that the garments are left with nice “hand”—that is, it feels nice, drapes well, and is largely free of wrinkles. It is believed that this is a result of residual solvent on the clothes. However, this benefit slowly goes away when the siloxane fluid evaporates. However, the addition of reactive siloxanes can impart a long-term benefit. The use of siloxane fluids improves the application (allowing easier application, through reaction, addition during the wash cycle, etc.) verses the use of aqueous article softeners where the softening material is added as an emulsion during the rinse. Acceptable fabric softeners include, for example, long chain reactive siloxanes, aldehydes and anhydrides.

Bleaches

In one embodiment of the invention it may be desirable to use bleach for enhanced stain removal and color brightening. Use of perborates, percarbonates, and sodium hypochlorite can be accomplished by dispersing the materials in the polar phase of the emulsified cleaning fluid. Bleaches such as isocyanric chloride or hydantoin chloride can also be used to improve solubility in the non-polar phase.

Optical Brighteners and Blueing Agents

In another embodiment of the invention optical brighteners and blueing agents may be added to correct for natural graying of articles with age and the redeposition of soils during the wash cycle. These materials can be either water-soluble or disperse in the non-polar medium.

Lint Scavengers and Depilatory Agents

In one embodiment of the invention, additives which have been developed to assist in the removal of hair fibers and extraneous fibers removed from the article during wash may be employed. Extraneous threads and hair are often electrostatically bound to article. In polar washing solvents, the charge can be dissipated by the conductive solvent or the solvent can support the charges on the fiber allowing the fiber to be carried out with the wash solution. In a non-polar fluid such as siloxanes, the hair and lint remains adhering to the more polar article. Reagents that can react with or coat the hair and lint fiber to make it more lipophilic can serve as additives in the siloxane wash to remove these undesired materials during cleaning. Aminosiloxanes are known to react with fiber surfaces to form non-durable siloxane coatings that could remove hair. Specially developed materials, such as 2-methylpyrimidinethinone siloxanes react rapidly and selectively with a proteinous surface to make the hair more appealing to the non-polar phase.

Inversion Inhibitors

In one embodiment of the invention, as ionic solvent levels increase, the ability of the emulsion to clean hydrophilic stains increases, however, increasing the polar solvent content also increases the chances for a gel to develop. This gel is an inverted emulsion, where the non-polar solvent is suspended in the polar solvent. The gel is not soluble in the primary emulsion and can break away from the article and clog lines, filters, screens, and other machine parts. This inverted emulsion is very heavy, and can cause the drum motor to stall and can block filters, screens, and pumps essential to the proper operation of the washing machine. The gel is also so thick that it cannot be spun out or rinsed off the washed clothes with pure non-polar solvent. Addition of more polar solvent will wash the gel away, but as stated earlier, addition of more polar solvent can be harmful to the article being cleaned.

In one embodiment of the invention, it is possible to inhibit gel formation through the addition of excess surfactants, particularly the silicone and siloxane surfactants mentioned above. However, the addition of excess surfactants can leave the article feeling slimy or greasy after a wash. It is also possible to inhibit gel formation through the use of additional detergents.

In another embodiment of the invention, a method of reducing gel formation is through the addition of salt to the wash solution. It has been found that addition of a salt to the cleaning emulsion can prevent the formation of the inverted emulsion. Common salts work well in the invention such as sodium chloride, calcium chloride, zinc chloride and potassium chloride. However, any salt that acts as a vapor pressure depressant will be effective. Concentration of salt in the polar solvent of less than 0.2 moles per liter are preferred. In one embodiment of the invention, concentrations of salt in the polar solvent are about 0.005 to 0.05 weight percent based on the weight of the salt and solvent combined. In another embodiment of the invention, concentrations of salt in the polar solvent are about 0.015 weight percent based on the weight of the salt and solvent combined.

The surfactants and additives may be added to the emulsions of the invention as individual components or may be added by the user prior to cleaning. Many of the surfactant and additive compositions contemplated by the invention may be achieved by adding commercially available laundry detergents which contain such compounds to a prepared emulsion. This would allow consumers to use their favorite detergent along with the emulsion of the invention.

Method of Cleaning Using Emulsions

In one embodiment the invention also comprises a method for cleaning articles using an embodiment of the aforementioned cleaning solution. The article to be cleaned is immersed in the cleaning solution, agitated for a length of time sufficient to dissolve the stains, and then the article is removed from the emulsion. There are several embodiments of the method of the invention, a few of which are enumerated herein.

In one embodiment of the invention, the practice of the invention takes place in a commercial dry-cleaning establishment. Machines in these establishments generally have capacities of 20 to 100 pounds of clothes. In another embodiment of the invention, the practice of the invention takes place in a home setting or public laundromat. In this embodiment a smaller washing machine is employed, generally with a capacity of 5 to 10 pounds of clothes.

In these embodiments of the invention, the articles to be cleaned are placed in a washing machine. This can be either a vertically oriented machine or a horizontally oriented machine. The articles are placed in a basket with holes to allow for drainage of the wash solution. The solution is then pumped into the machine to saturate the articles in the basket. This may be accomplished through a feed tube or by a spraying means which sprays the solution onto the articles in the basket as they are being agitated. The articles may be allowed to soak in the solution for a period of time to allow the cleaning solution to penetrate the articles and loosed the stains. The articles and the solution are then agitated for up to 20 minutes. The agitation time should be sufficient for the removal of any stains on the articles. Agitation time will vary depending on the types of article and stain as well as the formulation of the solution used. One skilled in the art will recognize the optimal agitation time for a given set of conditions.

In one embodiment of the invention, once the articles have been thoroughly agitated in the solution, they are separated from the cleaning solution. This may be achieved through a number of means either employed sequentially or in unison. Generally the wash solution is allowed to drain from the articles in the basket. The damp articles are then rotated at a speed of at least 350 revolutions per minute (rpm). In another embodiment of the invention the articles are rotated at between about 450 to about 750 rpm. This rotation will remove excess cleaning solution through centrifugal force.

In another embodiment of the invention, hot air may be passed through the articles as they are being rotated. Air is heated to between 110° F. and 170° F. In another embodiment of the invention the air is heated to between 140° F. and 170° F. In a further embodiment of the invention the air is heated to between 160° F. and 170° F. After the air is heated to the appropriate temperature, the hot air pass through the items volatilizing the remaining cleaning solution and removing it from the items.

After a predetermined amount of the cleaning solution has been removed from the articles, they may be removed from the machine. The cleaning solution, after it is separated from the articles, may be cleaned and reused. The cleaning solution may be cleaned through a number of means, including but not limited to a mechanical filter, particulate filter, water absorption media, and cleaning fluid adsorption media. The cleaning fluid adsorption media may be a packed bed column, a flat plate bed, a tortuous path bed, a membrane separator, a column with packed trays, combinations thereof or other similar means. The result is a cleaned solution which may be used repeatedly in the practice of the invention. The filter cartridge will have to be cleaned or replaced periodically as buildups of deposits occur.

In one embodiment of the invention a method for spot cleaning using a cleaning solution is provided. The cleaning solution of the invention is applied directly to the stain on the article to be cleaned. The solution may be rubbed into the stain or allowed to soak in for a predetermined length of time until the stain is suspended in the solution. Then the cleaning solution containing the stain may then be removed from the article. In another embodiment of the invention, after the solution is allowed to detach the stain from the article, the article may be washed according to other methods of the invention.

### EXAMPLES

### Example 1

Five pounds of clothes per load were washed with siloxane fluid alone and with water to establish baselines of cleaning and to determine performance relative to a list of critical factors for clothes care as seen in Table I. The stain removal and wrinkling tests were visual inspection tests with scores (1-5, 5 highest) assigned by trained observers. There are an infinite number of stain and article combinations, and the chemical interaction between stain and fiber has a large bearing on the difficulty of cleaning. Seven articles were chosen as representative of typical household laundry: acetate (acetate-modified cellulose, a hydrophobic fabric), cotton, linen, polyester (with the stains applied to the fleece side), rayon, silk, and wool. The fabrics were obtained from Textile Innovators, Inc., and conform to the test standards as free of sizings, etc. Ballast clothes were usually a 50/50 polyester/cotton blend or as the method indicated. The stains initially examined were chocolate ice cream, grape juice, red wine (burgundy), axle grease, and bacon grease. Later, modeling clay (a particulate soil) and grass juice were substituted for the greases. Wear tests counted threads removed from die cut fabric, and work (wash index) was determined by the change in brightness of graphite-impregnated clothes using a calorimeter.

TABLE I
Cleaning Performance Specifications

| | | | Water |
|---|---|---|---|
| Specification | Method | Target | Baseline |
| Stain Removal | AATCC 130-2000 | >3 | 4.6 |
| Oil Stain Removal | AATCC 130-2000 | >3 | 3.8 |
| Wrinkling | AATCC 124-1996 | >2 | 2.3 |
| Wear | Danish TIC, Series VII | <50 | 80 |
| Work | INSI/AHAM HLW-1-1987-4 | >70 | 110 |
| Shrinkage | AATCC | <3% | 8% |

The cleaning ability was assessed by standardized methods published by independent trade groups such as International Fabric Institute (IFI), Association of American Textile and Color Chemists (AATCC), American Home Appliance Manufacturers (AHAM), International Electro-Technical Commission (IEC), and the American Society for Testing and Materials (ASTM).

It was found that siloxane fluid was excellent for removing grease stains from clothing, even those that had been “set” by previous washing. However, siloxane fluid was poor at removing water-based stains, and the stain removal score did not meet the target, even when commercial siloxane dry-cleaning detergents were added. The wrinkling and wear values were 2 and 15, respectively, easily meeting the target.

### Example 2

Once the emulsion with surfactants and additives was found to be effective in the invention, the following tests were run to determine if commercial laundry detergents could be used as an all in one additive to the emulsions. In order to assess this, the top end detergents from three major manufacturers (Proctor and Gamble, Colgate-Palmolive and Lever Brothers) were tested under the same conditions with a 2 percent water solution and a 3 pound clothing load. Furthermore, the stain set was expanded to include additional consumer relevant stains beyond the original stain set (chocolate, wine, grape juice, grass and clay). ΔE is the distance in color space that cleaning has changed the stain from its original color and wash index is a measure of the effectiveness of the work. There wasn't any significant change across the standard stain set (Table II), but the detergents had varying efficacy against individual stains (Table III) This indicates that it is acceptable to use off-the-shelf products in a home system which incorporates a water emulsion.

TABLE II

| Manufacturer | Brand | AATCC | ΔE | Wash Index |
|---|---|---|---|---|
| Procter & Gamble | Tide | 4.40 | 9.00 | 62.30 |
| Lever Bros. | Wisk | 4.30 | 12.58 | 65.84 |
| Colgate-Palmolive | Fab | 4.40 | 12.82 | 83.06 |

TABLE III
Wider Stain Set

| | Spaghetti | Maple | | Yellow | Brown | | | | | Dri-write | | |
|---|---|---|---|---|---|---|---|---|---|---|---|---|
| | sauce | syrup | Milk | mustard | Mustard | Coffee | Ketchup | Crayon | Lipstick | marker | Mayo | AVERAGE |
| FAB/2% H₂O | 4.43 | 5.00 | 5.00 | 2.02 | 3.31 | 4.76 | 4.02 | 4.95 | 1.36 | 2.71 | 4.75 | 3.85 |
| TIDE/2% H₂O | 3.57 | 5.00 | 5.00 | 2.29 | 3.86 | 4.68 | 3.39 | 4.91 | 2.64 | 1.36 | 4.96 | 3.79 |
| Siloxane fluid (neat) | 2.48 | 1.26 | 2.67 | 1.05 | 1.38 | 2.69 | 1.17 | 4.71 | 2.14 | 1.21 | 4.10 | 2.26 |
| Water | 4.57 | 5.00 | 5.00 | 2.71 | 4.86 | 4.86 | 4.86 | 5.00 | 2.93 | 1.64 | 4.86 | 4.21 |

The foregoing description of several embodiments of the cleaning fluids and methods of cleaning of the invention have been presented for the purposes of illustration. Although the invention has been described in detail, it is to be clearly understood that the same is intended by way of illustration and example only and is not to be taken by way of limitations. Obviously many modifications and variations of the invention are possible in light of the above teaching. Accordingly, the spirit and scope of the invention are to be limited only by the terms of the appended claims.

1. A composition for use in cleaning comprising:
at least one polar co-solvent in an amount up to 10 percent based on the total weight of the solution;
at least one ionic surfactant in an amount up to 1 percent based on the total weight of the solution;
at least one emulsifier in an amount sufficient to form a stable emulsion; and
at least one non-polar solvent in an amount less than 100 percent based on the total weight of the solution;
wherein the composition is capable of solublizing both polar and non-polar stains.

2. The composition of claim 1, wherein the non-polar solvent comprises a siloxane containing compound.

3. The composition of claim 1, wherein the non-polar solvent comprises decamethylcyclopentasiloxane.

4. The composition of claim 1, wherein the polar co-solvent comprises water.

5. The composition of claim 1, wherein the polar co-solvent comprises polyethyleneglycol.

6. The composition of claim 1, wherein the polar co-solvent is present from 0.25 to 5 percent by weight based on the total weight of the composition.

7. The composition of claim 1, wherein the polar co-solvent is present from about 1.5 to 3.5 percent by weight based on the total weight of the composition.

8. The composition of claim 1, wherein the emulsifier comprises at least one of: a siloxane based emulsifier, polyethyleneoxide, polypropylene glycol, or sorbitan sesquioleate.

9. The composition of claim 1, wherein the ionic surfactant comprises a molecule with a highly charged head group and a hydrophobic tail, wherein the molecule further comprises a hydrocarbon tail of 12 to 20 carbon atoms.

10. The composition of claim 1, therein the ionic surfactant comprises at least one of sulfates, phosphates, and carboxylic acid salts.

11. The composition of claim 1, further comprising a salt.

12. The composition of claim 1, further comprising at least one of; fragrances, anti-deposition agents, builders, bleaches, dispersing agents, disinfectants, anti-foaming agents, deodorizers, wetting agents, dyes, and optical brighteners.

13. A composition for cleaning comprising:
93 to 99 weight percent decamethylcyclopentasiloxane based on the total weight of the composition;
0.25 to 5 weight percent water based on the total weight of the composition;
up to 1 weight percent of a siloxane based emulsifier based on the total weight of the composition; and
up to 1 weight percent of an ionic surfactant based on the total weight of the composition;
wherein the composition is capable of solublizing both polar and non-polar stains.

14. The composition for cleaning of claim 13, wherein the water is present from 1.5 to 3.5 weight percent based on the total weight of the composition.

15. A concentrated cleaning composition comprising:
up to 60 percent by weight of at least one polar co-solvent;
up to 7 percent by weight of at least one emulsifier;
up to 10 percent by weight of at least one surfactant; and,
at least one non-polar solvent in an amount less than 100 percent based on the total weight of the solution;
wherein the concentrated cleaning composition is capable of solubilizing both polar and non-polar stains.

16. The concentrated cleaning composition of claim 15, wherein at least one polar co-solvent is water.

17. The concentrated cleaning composition of claim 15, wherein at least one non-polar solvent is decamethylcyclopentasiloxane.

18. The concentrated cleaning composition of claim 15, wherein at least one emulsifier is a siloxane based emulsifier.

19. A method for cleaning articles comprising;
contacting the articles with the cleaning fluid of claim 1;
separating the cleaning fluid from the articles.

20. A method for cleaning stains from an article comprising;
applying the cleaning composition of claim 1 directly to the stain on the article;
rubbing the cleaning composition into the stain area until the stain becomes soluble in the cleaning composition.
removing the cleaning composition containing the stain from said article.

21. A method for cleaning stains from articles comprising;
applying the cleaning composition of claim 1 directly to the stain on the article;
allowing the cleaning composition to sit on the stain until the stain becomes soluble in the cleaning composition.
removing the cleaning composition containing the stain from the article.

22. The method of claim 21 wherein the cleaning composition containing the stain is removed from the article in a washing machine.

23. A method for cleaning articles comprising the steps of:
immersing the articles to be cleaned in a cleaning fluid, wherein the cleaning fluid comprises at least one non-polar solvent, at least one polar co-solvent, at least one ionic surfactant and, at least one emulsifier;
agitating said articles in said cleaning fluid;
separating said cleaning fluid from said articles.

24. The method recited in claim 23, wherein the step of separating said cleaning fluid from said articles comprises the steps of allowing the cleaning fluid to drain from said articles, rotating the tub at greater than 350 rpm, and heating the article and remaining cleaning fluid with an air stream between 110° F. and 170° F. to remove any remaining cleaning solution.

25. The method recited in claim 23, further comprising the step of filtering the cleaning solution through a carbon filter.
